(19) United States
(12) Patent Application Publication
(10) Pub. No.: US 2007/0080173 A1
(43) Pub. Date: Apr. 12, 2007

(54) Fluid dispenser with a safety dispensing actuator

(76) Inventors: Matthew T. Coe, Annandale, NJ (US); Hung Mach, Flushing, NY (US); Mitchell Tung, Bridgewater, NJ (US)

Correspondence Address: WATOV & KIPNES, P.C., P.O. Box 247, Princeton Junction, NJ, 08550, US

(21) Appl. No.: 11/245,392

(22) Filed: Oct. 6, 2005

(51) Int. Cl. B67D 5/00; B67D 5/40

(52) U.S. Cl. 222/153.13; 222/384

(57) ABSTRACT

A fluid dispenser includes a pump in fluid communication with a fluid outlet. The fluid dispenser further includes a securing mechanism for securing the pump to a fluid source containing a fluid product, a movable dispensing actuator in operative engagement to the pump where the dispensing actuator is adapted to urge the pump to convey the fluid product from the fluid source to the fluid outlet when moved from a first position to a second position, and a retractable projection extending from the dispensing actuator for reversible engagement to a fixed portion of the fluid dispenser wherein the dispensing actuator is immobilized in the first position.

### FIELD OF THE INVENTION

The present invention relates to fluid dispenser packaging, and more particularly to a fluid dispenser having a safety dispensing actuator that substantially reduces the incidence of spillage, contamination, and accidental or inadvertent release of the fluid product from a container.

### BACKGROUND OF THE INVENTION

Containers are well known in the art, and may be used to hold a range of products including pharmaceuticals, cosmetics, household cleaners, personal care compositions, and foodstuffs. A fluid dispenser packaging is a form of a container that can store and dispense quantities of fluid, typically in a metered dose, via a user-actuated dispensing mechanism. A typical fluid dispenser packaging generally comprises a reservoir for holding a fluid, a fluid dispenser having a pump assembly fluidly coupled to the reservoir, and a user operable actuator for urging the pump assembly to dispense the fluid from the reservoir. Although current fluid dispenser packaging encompass a range of designs and features, few are designed to prevent spillage, contamination and accidental or inadvertent release of fluid products that may be harmful to people.

Accordingly, there is a need for a fluid dispenser for use in a fluid dispenser packaging that is designed to dispense a quantity such as a metered dose, of a fluid product such as a liquid in a manner that promotes safe handling and storage, while reducing the incidence of spillage, contamination, accidental or inadvertent dispensing of the fluid product. There is a further need for a fluid dispenser that is readily operable by those with limited dexterity. Furthermore, there is a need for a fluid dispenser that is simple and cost efficient to make and use.

### SUMMARY OF THE INVENTION

The present invention relates generally to a fluid dispenser for incorporation into packaging for dispensing a fluid product such as a liquid in a manner that promotes or facilitates safe storage and handling of the fluid product. The fluid dispenser of the present invention is designed to prevent or at least substantially reduce the incidence of spillage, contamination, or accidental or inadvertent release of the fluid product. The fluid dispenser of the present invention includes a safety pump assembly and a dispensing actuator designed to be selectively operable by the proper user. According to the present invention, the safety dispensing actuator operates to effectively prevent unsupervised access to the fluid product by small children, for example. In addition to providing safety measures, the fluid dispenser is designed to be readily operable by those with limited dexterity such as, for example, elderly users. The fluid dispenser of the present invention can be readily implemented for use in existing commercially available packaging configurations.

The fluid dispenser of the present invention may be used to dispense any form of fluid including, but not limited to, liquids, solutions, creams, pastes, gels, foams, emulsions, ointments, slurries, and other flowable substances. The present invention is especially suitable for the packaging and dispensing of pharmaceuticals and personal care products.

In one aspect of the present invention, there is provided a fluid dispenser comprising:

a pump in fluid communication with a fluid outlet;

means for securing the pump to a fluid source containing a fluid product;

a movable dispensing actuator in operative engagement to the pump, the dispensing actuator being adapted to urge the pump to convey the fluid product from the fluid source to the fluid outlet when moved from a first position to a second position; and

a retractable projection extending from the dispensing actuator for reversible engagement to a fixed portion of the fluid dispenser wherein the dispensing actuator is immobilized in the first position.

### BRIEF DESCRIPTION OF THE DRAWINGS

The following drawings in which like reference characters indicate like parts are illustrative of embodiments of the invention and are not intended to limit the invention as encompassed by the claims forming part of the application.

FIG. 1 is a perspective view of a fluid dispenser secured to a container for one embodiment of the present invention;

FIG. 2 is a perspective view of the fluid dispenser shown in FIG. 1;

FIG. 3 is a side elevational view of the fluid dispenser along lines 3-3 of FIG. 2 in accordance with the present invention;

FIG. 4 is a front elevational view of the fluid dispenser along lines 4-4 of FIG. 2 in accordance with the present invention;

FIG. 5 is a cross sectional view of the fluid dispenser and container along lines 5-5 of FIG. 1 in accordance with the present invention;

FIG. 6 is an elevational view of a fluid dispenser secured to a container for a second embodiment of the present invention; and

FIG. 7 is a cross sectional view of the fluid dispenser and container of FIG. 6 in accordance with the present invention.

### DETAILED DESCRIPTION OF THE INVENTION

The present invention is directed generally to a fluid dispenser designed to be permanently or reversibly secured to a container for dispensing via a manual actuator a quantity of a fluid product such as a liquid, which is stored in the container. The fluid dispenser of the present invention is designed to promote safe storage and handling of the fluid product, while still providing ease of operation for those with limited dexterity such as, for example, elderly users. The fluid dispenser of the present invention is constructed to prevent or at least substantially reduce the incidence of spillage, contamination, and accidental or inadvertent release of the fluid product. The fluid dispenser of the present invention is also adapted to prevent unsupervised access by small children. Thus, the fluid dispenser of the present invention is especially suited for use in child-proof packaging, for example.

In one form of the present invention, the fluid dispenser includes a pump in fluid communication with a fluid outlet. The fluid dispenser further includes a securing mechanism for securing the pump to a fluid source containing a fluid product, a movable dispensing actuator in operative engagement to the pump where the dispensing actuator is adapted to urge the pump to convey the fluid product from the fluid source to the fluid outlet when moved from a first position to a second position, and a retractable projection extending from the dispensing actuator for reversible engagement to a fixed portion of the fluid dispenser wherein the dispensing actuator is immobilized in the first position.

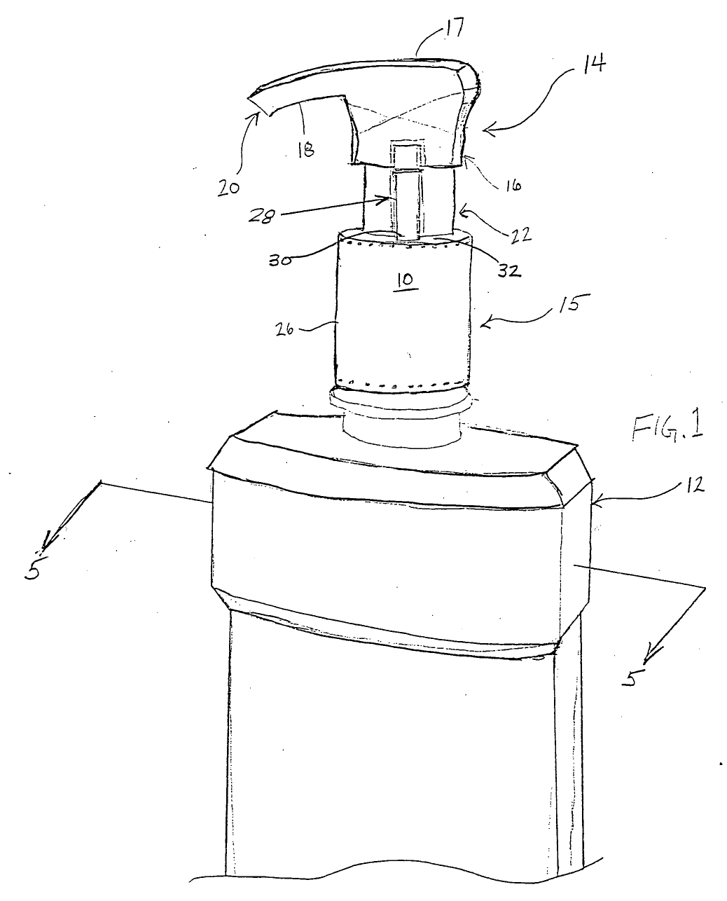

With reference to FIG. 1, there is shown for one embodiment of the present invention a fluid dispenser identified generally by the reference numeral 10 in an operable position engaged to a container 12. The fluid dispenser 10 is useful for dispensing dosable fluid products including but not limited to medications, vitamins, nutraceuticals, skin care formulations, dental hygiene compositions including mouth rinses, and pharmaceutical compositions, each of which may be in the form of liquids, solutions, creams, pastes, gels, foams, ointments, slurries, and other flowable compositions.

The fluid dispenser 10 is securely attached to the container 12 which is designed to accommodate a quantity of a fluid product (not shown) for storage. The fluid dispenser 10 includes a dispensing actuator 14, and a body member 15. The dispensing actuator 14 is adapted for operative engagement with the body member 15. The fluid dispenser 10 operates to draw the fluid product in metered amounts from the container 12 for dispensing, upon activation of the dispensing actuator 14 by the user. The dispensing actuator 14 includes head portion 16 with a contact surface 17, and a spout 18 defining a fluid outlet 20, and a stem portion 22 extending from the head portion 16 to the body member 15. The contact surface 17 is adapted to receive a downward force applied thereon by a user.

The body member 15 houses a pump 24 described in connection with FIG. 5 hereinafter for moving the fluid product from the container 12. The body member 15 further includes a collar 26 for reversibly securing the fluid dispenser 10 to the container 12 via a threaded engagement therebetween to enable the fluid dispenser 10 to be removed from the container 12, thus allowing the container 12 to be refilled and/or the dispenser cleaned. Alternatively, the collar 26 may be irreversibly secured to the container 12. In this embodiment the fluid dispenser 10 and the container 12 are intended to be discarded when the fluid has been completely discharged from the container 12. Furthermore the preventive measures against accidental or inadvertent release of the fluid product and unsupervised access by small children are greatly enhanced when the fluid dispenser 10 and container 12 are permanently secured to each other.

The dispensing actuator 14 is operatively engaged to the body member 15 in association with the pump 24 to urge the fluid product out of the fluid dispenser 10. The dispensing actuator 14 moves reciprocally in a sliding action from an upright position to a depressed position. The dispensing actuator 14 is urged to the depressed position by applying a downward force on the contact surface 17 of the head portion 16 to push the stem portion 22 into the body member 15. During the downstroke movement of the dispensing actuator 14, the fluid product is dispensed through the fluid outlet 20 by the pump 24 as will be described hereinafter. The dispensing actuator 14 is spring biased upwardly, typically by a spring assembly 42 (See FIG. 5), to rest at the upright position upon releasing the downward force on the contact surface 17.

The fluid dispenser 10 further includes a locking mechanism 28 forming part of the dispensing actuator 14. The locking mechanism 28 is located on the opposing sides of the dispensing actuator 14 in the stem portion 22. The locking mechanism 28 releasably locks the dispensing actuator 14 in the upright position during storage or non-use, and prevents the downstroke movement of the actuator 14 that may cause spillage, contamination, and accidental or inadvertent release of the fluid product. The locking mechanism 28 includes a stepped protrusion 30 extending radially outward under the action of a spring (not shown) from the stem portion 22 of the dispensing actuator 14. In a locked position, the stepped protrusion 30 abuts against a shoulder area 32 extending along the top surface of the body member 15, thus effectively preventing the stem portion 22 from moving into the body member 15.

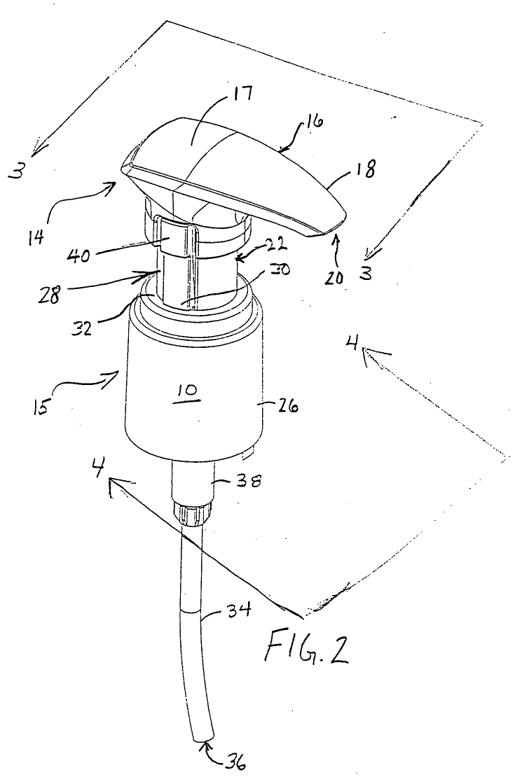

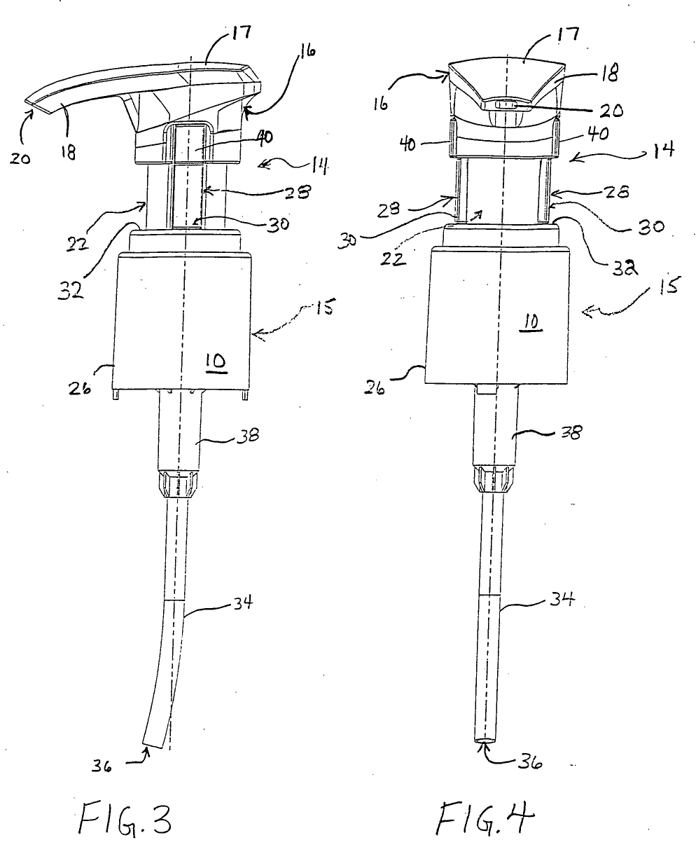

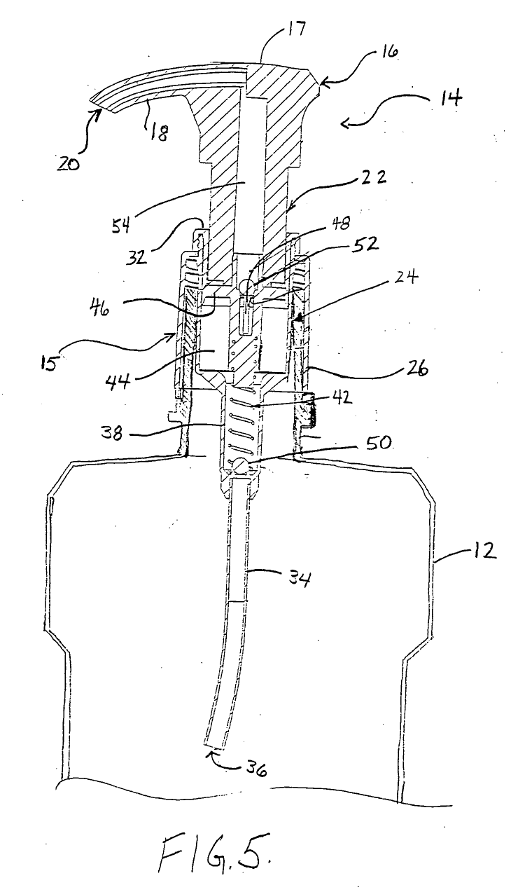

Referring to FIGS. 2 through 4, there is shown the fluid dispenser 10 unsecured from the container 12 for one embodiment of the present invention. The body member 15 further comprises a dip tube 34 with a fluid inlet 36 at the distal end in fluid communication with a pump inlet 38 of the pump 34. The distal end of the dip tube 34 lies below the surface of the fluid product within the container 12. During dispensing, the fluid product from the container 12 enters the pump 34 via the fluid inlet 36 of the dip tube 34 and the pump inlet 38.

As previously described above, the locking mechanism 28 serves to immobilize the dispensing actuator 14 in the upright position to prevent actuation of the pump 24. The stepped protrusions 30 are resiliently biased radially outward on opposed sides of the stem portion 22 by a spring mechanism (not shown). The locking mechanism 28 further includes a release key 40 located at the upper end of the stepped protrusion 30. An inwardly force can be applied to the release key 40 to move the stepped protrusion 30 radially inward beyond the inner periphery of the shoulder area 32 of the body member 15, thereby providing the dispensing actuator 14 clearance to move within the body member 15. In this manner, the stepped protrusion 30 can be moved to disengage the locking mechanism 28, thus allowing the dispensing actuator 14 to move freely within the body member 15 and dispense the fluid product. Once the locking mechanism 28 is disengaged, the stem portion 22 can slide into the body member 15 to actuate the pump 24 wherein the fluid product is correspondingly dispensed through the fluid outlet 20 during the downstroke cycle.

After completion of a downstroke cycle, the dispensing actuator 14 returns to the upright position by the spring assembly 42 (See FIG. 5). At the upright position, the stepped protrusion 30 is urged to a radially outward position by the spring mechanism (not shown) to re-engage the shoulder area 32 of the body member 15 and re-immobilize the dispensing actuator 14 to prevent dispensing during non-use or storage.

Referring to FIG. 5, the pump 24 comprises a pump chamber 44 in fluid communication with the pump inlet 38, a reciprocating pump piston 46 occupying the pump chamber 44, and a pump outlet 48. The pump piston 46 is operatively engaged to the stem portion 22 of the dispensing actuator 14. The pump piston 46 slides reciprocally between a top position and a bottom position within the pump chamber 44 in accordance with the movement of the dispensing actuator 14. The spring assembly 42 located within the pump inlet 38 is attached to the pump piston 46 to resiliently bias the pump piston 46 in the top position during non-use or storage.

The pump 24 further comprises a first ball check valve 50 located in the pump inlet 38 and a second ball check valve 52 located in the pump outlet 48 to maintain a one-way fluid flow from the fluid inlet 36 to the fluid outlet 20. The pump 24 draws the fluid product from the container through the dip tube 34 and the first ball check valve 50 of the pump inlet 38 into the pump chamber 44 during the upstroke cycle of the pump piston 46. The first ball check valve 50 allows the fluid product to pass into the pump chamber 44, while preventing backflow of the fluid into the container 12.

The drawn fluid in the pump chamber 44 is pumped through the second ball check valve 52 of the pump outlet 48 during the downstroke cycle of the pump piston 46 by urging the dispensing actuator 14 downwardly. The fluid flows into a dispensing conduit 54 in communication with the fluid outlet 20. The second ball check valve 52 allows the fluid product to pass into the dispensing conduit 54 for dispensing through the fluid outlet 20, while preventing backflow of the fluid into the pump chamber 44. At the end of the downstroke cycle, the spring assembly 42 urges the pump piston 46 and the dispensing actuator 14 back to the upright position wherein the pump chamber 44 is correspondingly refilled with the fluid product drawn from the container 12 by the vacuum created during the upstroke of the pump piston 46.

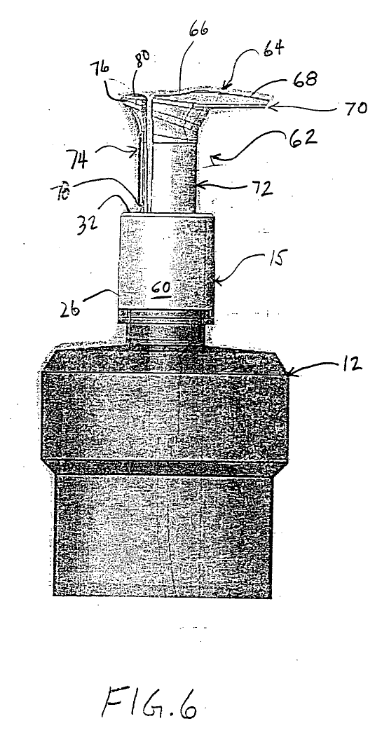

Referring to FIG. 6, a fluid dispenser designated generally by reference numeral 60 is shown in accordance with a second embodiment of the present invention. The fluid dispenser 60 is substantially identical to that shown in FIGS. 1-5 such that like parts will be identified by like reference numerals. The main difference from the embodiment of FIG. 1 is the form of the dispensing actuator and locking mechanism as will be described hereinafter.

The fluid dispenser 60 includes a dispensing actuator 62 having a head portion 64 with a contact surface 66 and a spout 68 defining a fluid outlet 70, a body member 15, and a stem portion 72 operatively engaged to the body member 15. The dispensing actuator 62 is adapted to move vertically with respect to the body member 15 and operating in substantially the same manner as described in the previous embodiment. The fluid dispenser 60 further includes a locking mechanism 74 comprising a movable release lever 76 for releasably locking the dispensing actuator 62 in the upright position during non-use or storage. The release lever 76 is biased radially outward from the dispensing actuator 62, and includes a lip protrusion 78 at the lower end thereof. When the dispensing actuator 62 is at the upright position, the lip protrusion 78 is operatively engaged to the shoulder area 32 extending along the top surface of the body member 15. This effectively immobilizes the dispensing actuator 62 in the upright position, and prevents fluid dispensing that may result in spillage, contamination, or accidental release of the fluid product from the container 12.

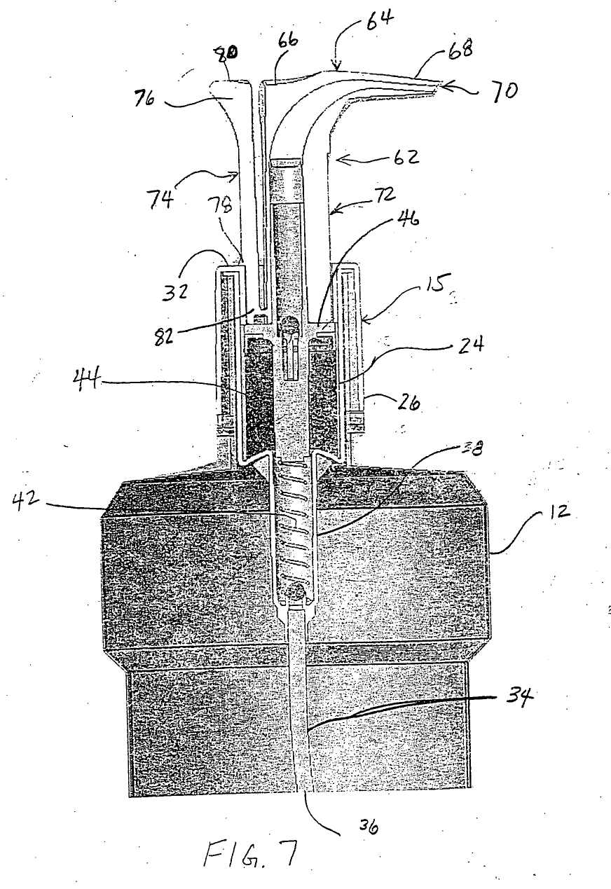

Referring to FIG. 7, the release lever 76 is positioned coextensively in a spaced apart manner with the stem portion 72 of the dispensing actuator 62. This provides the release lever 76 with a degree of movement in the direction of the stem portion 72 of the dispensing actuator 62. The lower end of the release lever 76 is formed integrally with the stem portion 72 of the dispensing actuator 62. The lip protrusion 78 is located proximate to the lower end of the release lever 76 opposite from the stem portion 72 of the dispensing actuator 62. The lip protrusion 78 abuttingly engages the shoulder area 32 of the body member 15 when the dispensing actuator 62 is located at the upright position.

The lip protrusion 78 disengages from the shoulder area 32 upon application a radially inward force on the contact area 80. This moves the release lever 76 toward the dispensing actuator 62 and disengages the lip protrusion 78 from the shoulder area 32. Once the lip protrusion 78 is cleared, the dispensing actuator 62 is free to move downward to the depressed position during which the fluid product is dispensed through the fluid outlet 70. When the dispensing actuator 62 returns to the upright position by the spring biased action of the spring assembly 42, the lip protrusion 78 re-engages to and abuts against the shoulder area 32 of the body member 15, thereby automatically re-securing the fluid product in the container 12.

What is claimed is:

1. A fluid dispenser having a fluid outlet, comprising:
a pump in fluid communication with the fluid outlet;
means for securing the pump to a fluid source containing a fluid product;
a movable dispensing actuator in operative engagement to the pump, said dispensing actuator being adapted to urge the pump to convey the fluid product from the fluid source to the fluid outlet when moved from a first position to a second position; and
a retractable projection extending from the dispensing actuator for reversible engagement to a fixed portion of the fluid dispenser wherein the dispensing actuator is immobilized in the first position.

2. The fluid dispenser of claim 1 wherein the securing means comprises a collar member adapted for coupling with the fluid source.

3. The fluid dispenser of claim 2 wherein the retractable projection reversibly engages a portion of the collar member.

4. A fluid dispenser packaging, comprising:
a container holding a quantity of a fluid product;
a pump in fluid communication with the container and a fluid outlet;
a movable dispensing actuator in operative engagement to the pump, said dispensing actuator being adapted to urge the pump to convey the fluid product from the fluid source to the fluid outlet when moved from a first position to a second position; and
a retractable projection extending from the dispensing actuator for reversible engagement to a fixed portion of the fluid dispenser wherein the dispensing actuator is immobilized in the first position.
